(19) United States
(12) Patent Application Publication
(10) Pub. No.: US 2015/0190310 A1
(43) Pub. Date: Jul. 9, 2015

(54) SPECIMEN COLLECTION DEVICE AND METHOD OF USE

(71) Applicants: Donna S. McBride, North Wildwood, NJ (US); Michael J. McBride, JR., North Wildwood, NJ (US)

(72) Inventors: Donna S. McBride, North Wildwood, NJ (US); Michael J. McBride, JR., North Wildwood, NJ (US)

(21) Appl. No.: 14/149,437

(22) Filed: Jan. 7, 2014

(51) Int. Cl. A61J 1/14; B01L 3/00; B65D 25/22; B65D 25/54; B65D 43/16

(52) U.S. Cl. CPC A61J 1/1412; B65D 25/54; B65D 43/16; B65D 25/22; B01L 3/50

(57) ABSTRACT

A medical device for collecting bodily samples, such as urine specimens from a human or animal, comprising a collection cup, and a detachable or separate handle. The handle proximal member may be telescopic with multiple sections for its extension, or one section. The handle distal member may comprise one prong that is detachable from the cup after its use; or, it may comprise a two prong fork that lies underneath a cup's ledge, and expandable to support different diameter cups. The distal member may also comprise a pivoting means to enable the handle to bend to maintain the cup horizontally. The collection cup may comprise various shapes and sizes, and the lid able to be fixed to the handle's distal member when the cup is in use. The cup may also inherently emit light, or a light source may be mounted on the handle to illuminate the cup.

### FIELD OF THE INVENTION

The present invention relates to the field of medical patient care, and specifically to the collection of specimens for testing and analysis.

### BACKGROUND OF THE INVENTION

Medical testing of patient's bodily fluids is often required in medical facilities and/or at home in order to properly diagnose and treat a patient with a medical condition such as diabetes. And even after a patient has been diagnosed, at home collection of bodily samples, such as urine samples, is often required to monitor a medical condition. For example, a physician may require a patient to regularly test their blood glucose level using urinalysis test strips to monitor their diabetes.

The patient may in fact be a human but also an animal, such as a dog or cat, for which regular testing of uncontaminated urine samples is a difficult, laborious process. This process can be further impeded if the owner is outside with the pet during hours of dark.

The prior art discloses a few devices designed to assist the pet owner. For example, U.S. Pat. No. 7,721,596 by Gaydos et al discloses a device for retrieving urine samples from animals comprising a collection tray having a first and second end separated by two opposing sides and defining a catch basin. The tray is open, without a means to seal the contents.

U.S. Pat. No. 7,775,568 by Scott discloses an animal collection device with a battery powered light source comprising a light emitting diode that is mounted on the device's handle. The light shines on and around the “collection pod” with an appearance of a soup ladle and which is also open, without a means to seal the contents.

US 20100194128 by Langley discloses a device comprising a short collapsible frame supporting a collection bag that is closed when the frame is folded. The bag is not sealable from seepage.

Therefore, there is a need within the art for a collection device comprising: 1) an attached lid that is easily opened and positioned out-of-the-way, and then closed while being impermeable to liquid seepage; 2) a collapsible and adjustable handle to increase portability and storage and maneuverability of the device; and, 3) a self-powered light source near the point of collection.

### SUMMARY OF THE INVENTION

The present invention is directed to collection devices and their method of use in collecting bodily samples, such as urine or stool, from a patient to diagnose or monitor the patient's medical condition. The size of the device is determined by the size of the patient. The “user” of the device is the person holding the handle while the device is in use, and is herein referred to as the “collector”. When the patient is a human, then the collector and patient are one in the same. The patient may also be a domesticated pet (e.g. dog or cat), and/or animal residing within a zoo, farm, or other non-wild area.

The device may primarily comprise two separate, or inseparable, components: a collection cup, with a sealable lid; and a handle to prevent the user from having to make direct contact with the cup while it is in use. The handle in the various embodiments may further comprise a proximal (relative to the collector) member and a distal member (near the patient). The length of the handle and whether or not it is re-useable or intended for a one time use may depend on its environment, and/or its intended use, and/or the type of patient.

Furthermore, the proximal and distal members may be connected together by a joint or ratchet means that permits the angle between these two members to be adjusted relative to each other, such as a metal or plastic ball or spherical pivot joint. The angle of the distal member is adjusted relative to the proximal member so as to keep the cup approximately horizontal to the ground when in use.

In one embodiment as shown in FIGS. 1-8, the handle comprises a two prong fork on the distal end supporting the cup's weight; and, a telescopic proximal end. A telescopic proximal handle comprises a hollow tube housing tubular or cylindrical sections that slide in/out and are adjustable in length to accommodate the collector's height. When in use, the proximal member is extended to a length permitting the collector to be able to comfortably use the device (e.g. the user is not required to squat or bend down low to the ground when the patient is an animal). And when not in use, the pivot joint in the telescopic handle may not be visible when the handle is completely collapsed.

The two components in this embodiment are separable so that when the device is in use, the collection cup is inserted into the two prong fork and the proximal end of the handle is extended to the appropriate length. And when the device is not in use, then the cup and handle are stored separately, and the handle is fully collapsed.

In another embodiment as shown in FIGS. 8-12, the handle comprises a two prong fork on the distal end supporting the cup's weight; and, only one section on the proximal end (as compared to multiple sections on the telescopic handle). The entire length of the handle is sufficient to permit a human to grasp the proximal end in one or two palms as per their choice (e.g. 7-10 inches).

In another embodiment (e.g. hospital patient), the two components are initially inseparable, exist as one unit, and the handle is one section that is not collapsible, but the handle can be easily snapped off of the cup after the cup is filled. The handle may also be disposable and intended for a one-time use, and made from a recyclable plastic. In the exemplification illustrated in FIGS. 13-15, the cup is cylindrical with a means to attach the handle to the cup's side wall; and, the handle comprises only one section on the proximal end (as compared to multiple sections on the telescopic handle) connected to one prong with a slight bend near the handle's distal end. The slight bend may or may not comprise a pivoting joint or other flexible member or material to permit the cup to be adjusted to a position horizontal relative to the ground when in use.

### Collection Cup

Various types and shapes of cups are suitable for use in the device (e.g. see FIGS. 16 and 17). In the various embodiments, the cup may be flat bottomed, with an open top, and a partially or completely removable lid. The side wall of the cup is also made of material that enables the collector to see the fluid levels easily, such as transparent or opaque material. The top and bottom sides-surfaces of the cup can be made of the same material as the side wall, or a different material. The entire cup may also be made of transparent plastic material that is impermeable to seepage by liquids.

In one embodiment (e.g. FIG. 4), the cup is funnel or conical like with a flat bottom, also known as an inverted frustoconical shape (i.e. the cup's side wall) comprising a top surface/rim/plane with a diameter greater than the bottom surface/rim/plane. In another embodiment (e.g. FIGS. 14 and 15), the cup is cylindrically shaped (i.e. the cup's side wall comprising a top surface/rim/plane with the same diameter as the bottom surface/rim/plane.

The cup may further comprises, in one embodiment, a concave indentation on opposing sides of the cup aligned with the two prong fork of the handle that creates a ledge for one prong each to lie under (i.e. flush against) while supporting the weight of the cup (e.g. FIG. 4). In another embodiment, the concave indentation runs 360 degrees around the cup that the handle will fit around the cup from any direction (FIGS. 16 and 17).

The lid of the cup is snapped on/off and is impermeable to liquid seepage when it is securely snapped on the top of the cup. The lid may further comprise an attachment means, such as a tab, securing it to the cup, such as the cup rim, at a point aligned with the handle distal member. The attachment means enables the lid to not obstruct the cup's usage by bending the lid 180 degrees back to lie flush on the handle distal member when the cup is in use.

The lid may further comprise a means to attach the top surface of the lid to the handle distal member when the cup is in use. In one embodiment, a clamp comprising two parallel plane members snap the top surface of the lid to the top surface of the pole. In another embodiment, fixation means may comprise Velcro®-like material on the lid's top surface attaching to material on the top surface of the handle-pole.

The collection cup may further comprise markings for volumes, such as on the side wall of the cup. The cup may also comprise a means for the user to easily date and name the cup. For example, the whole or part of the upper, outer surface of the cup lid, and/or the cup side wall may comprise material that a user is able to permanently and clearly write on with an ink pen.

### Additional Features

The device may further comprise a solar or battery powered light source attached near the distal end of the handle and projecting down onto the cup.

In another embodiment, the cup is fabricated from material that emits light naturally (i.e. glow-in-the-dark). For example, the cup is made from plastic comprising a phosphor, such as Zinc Sulfide and Strontium Aluminate.

The device may further comprise a means to hang the device from a hook when not in use, such as a hole in or a strap extending from the handle's proximal end.

And the device may further comprise a means to attach a bag and/or other container to the handle-pole to carry materials, such as diabetic test strips.

Additionally, the prongs in the two prong handle may comprise material that makes the prongs flexible and able to expand and contract relative to each other. This enables the prongs to fit around cups of different diameters.

### BRIEF DESCRIPTION OF THE DRAWINGS

The above and other features, aspects, and advantages of the present invention will become better understood with regard to the following description, appended claims, and accompanying drawings where:

FIGS. 1-8 illustrate one embodiment of a device with a telescopic stick and two-prong fork supporting a cup with two opposing side indentations.

FIG. 1 is a side perspective view of the device for one embodiment comprising a conical shaped cup.

FIG. 2 is a view of the device disassembled comprising the handle and the collection cup.

FIG. 3 illustrated the collapsibility of the handle with the distal member retracting into the proximal member except for the two prong fork.

FIG. 4 is a side perspective view of the collection cup with the cup's lid bent back 180 degrees.

FIG. 5 is an elevated perspective view showing the collection cup with the lid open and connected to the handle's distal member.

FIG. 6 is a bottom perspective view of FIG. 5 illustrating the cup's lid attached to the handle's distal member.

FIG. 7 is an illustration of one embodiment for a device with a strap to carry the device and a clip to attach bags or the like to the device.

FIG. 8 is an illustration of one embodiment for a device with a light source attached to the handle to illuminate the collection cup.

FIGS. 9-12 illustrate another embodiment of the device comprising a two prong fork distal member and a short, one section proximal handle member.

FIG. 9 demonstrates the two prong fork distal member and a short, one section proximal handle member without the cup.

FIG. 10 demonstrates the short handle of FIG. 9 with a frustoconical cup.

FIG. 11 provides a modification of the short handle with a non-slip material covering part of the prongs of the fork.

FIG. 12 provides a modification of the short handle with a non-slip material covering all or most of the exterior surface of the prongs of the fork.

FIGS. 13-15 illustrate another embodiment of the device comprising a one prong fork distal member connected to a short handle, and supporting a cylindrical cup.

FIG. 13 illustrates the one prong fork distal member connected to a short handle without the cup.

FIG. 14 is a bottom perspective view of the handle of FIG. 13 supporting a cylindrical cup.

FIG. 15 is a top perspective view of the handle of FIG. 13 supporting a cylindrical cup.

FIG. 16 displays non-limiting exemplifications of various types of collection cups suitable for use in the device.

FIG. 17 displays the various cups of FIG. 16 with their lids completely off and detached from the cup, or open but attached to the cup bottom via a tab.

### DETAILED DESCRIPTION

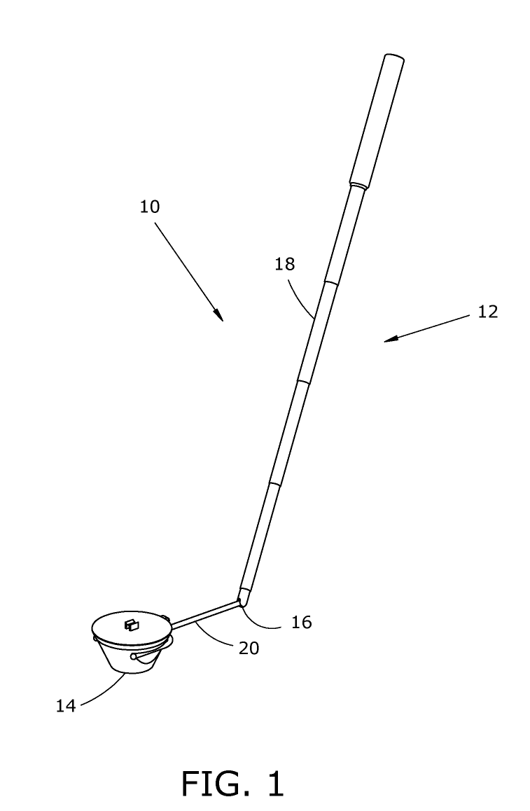

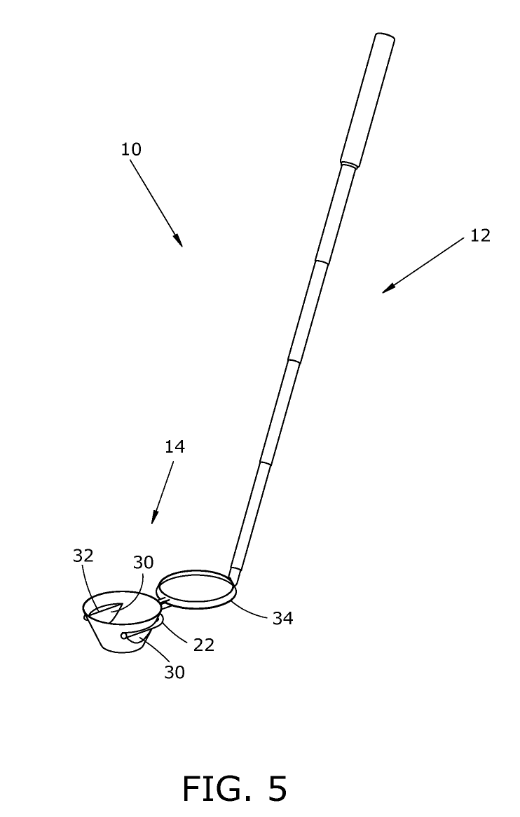

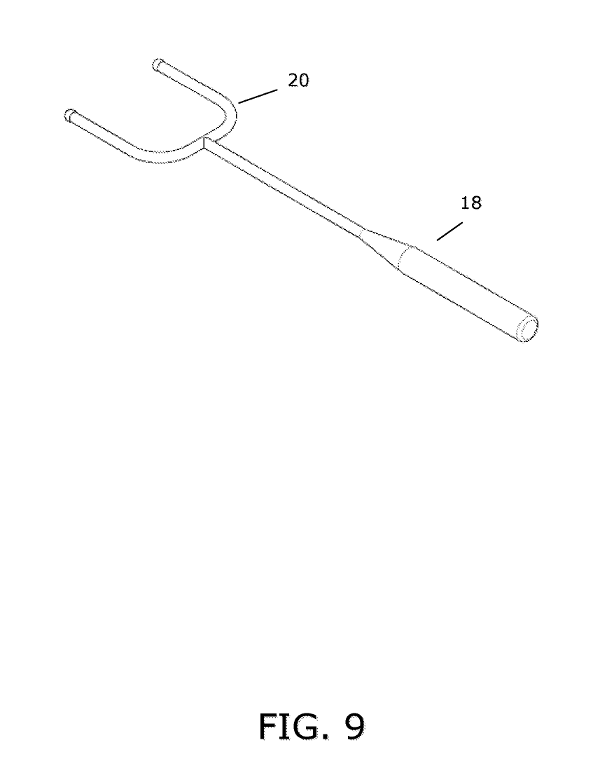

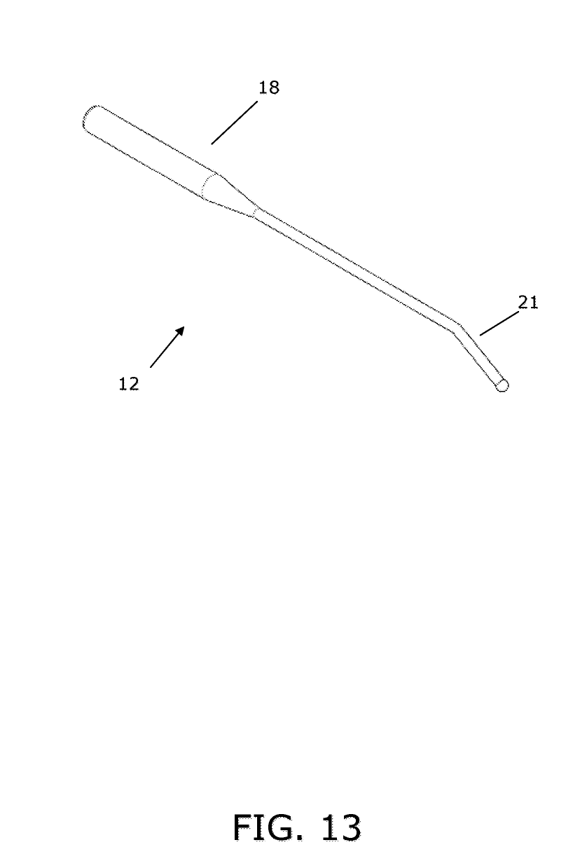

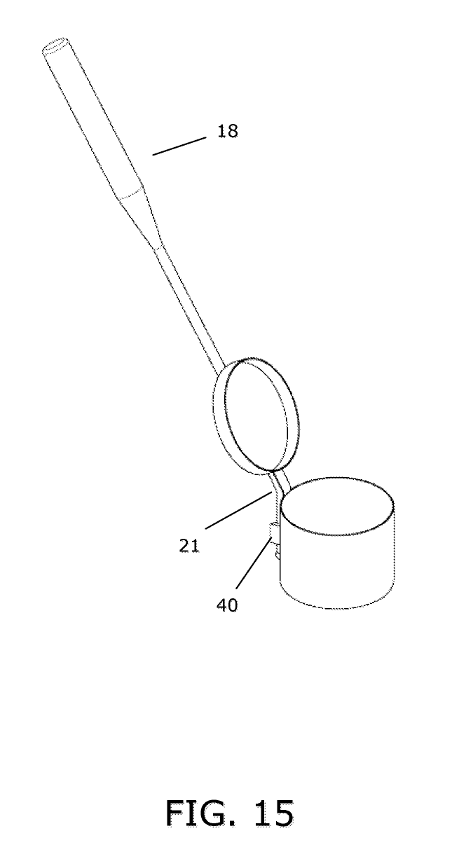

There are multiple variations of the collection device comprising a handle used with a collection cup as disclosed herein, with some of those variations demonstrated in the figures. Notably, FIGS. 1-8 provide an illustration of an exemplification appropriate for use with an animal comprising a two prong fork on the handle distal end connected to a telescopic handle proximal end with multiple collapsible and extendable sections. FIGS. 9-12 exemplify another embodiment comprising a two prong fork on the handle distal end connected to a short, one section handle proximal end that may be used for home health care. And FIGS. 13-15 exemplify yet another embodiment for use in medical facilities where a one prong fork on the handle distal end is connected to a short, one section handle proximal end while also being affixed to the collection cup. After the cup is filled, the handle can be snapped off and disposed of. It is understood, though, that other embodiments and modifications of these embodiments are envisioned in the present invention. For example, additional features of the collection device, such as means of hanging the device, and means of providing a light source on the collection cup are demonstrated in one embodiment, but these features may be added to any of the embodiments as disclosed herein. Likewise, various types of collection cups are envisioned with this disclosure for use with the handle, including those described and exemplified in the figures, as well as those that are commercially available.

Collection Device with Telescopic Handle

As shown in FIG. 1, the device 10 of the present invention comprises the handle 12 in an extended position supporting the collection cup 14. The ball pivot joint 16 in the handle 12 is positioned so that the proximal end 18 of the handle is about 110 degrees from the distal end 20 in order to maintain the cup 14 horizontal to the ground.

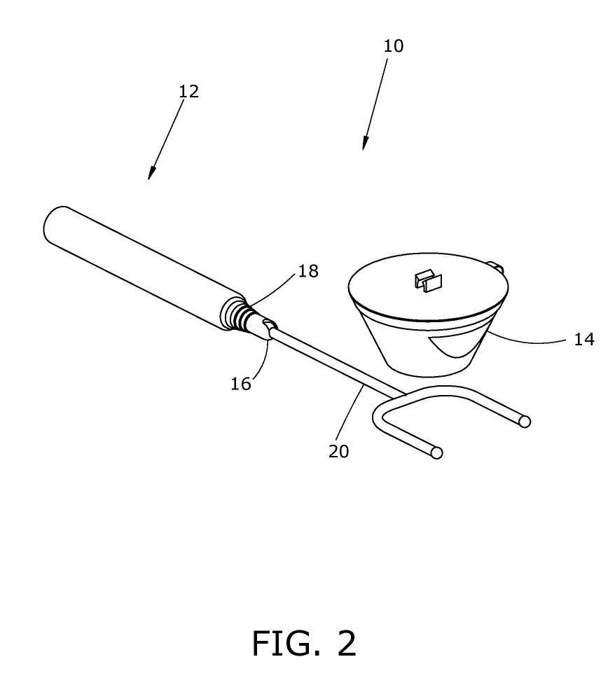

The two primary members of device 10 are shown in a storage configuration in FIG. 2 comprising the handle 12 separate from the collection cup 14. The handle's proximal member 18 is collapsed and the distal end 20 is aligned with the proximal end 18 such that the ball pivot joint 16 positions the two members in a 180 degree alignment.

### Collapsible Handle

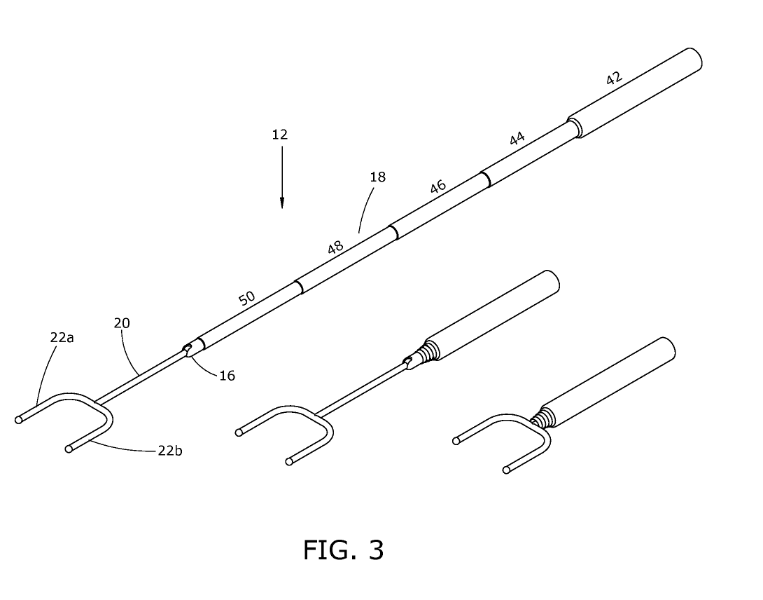

As further illustrated in FIG. 3, one embodiment of the handle 12 comprises a telescopic like expandable and collapsible-retractable pole. The handle proximal member is hollow and telescopic with each section 42, 44, 46, 48, and 50 of the proximal member sliding into the adjoining proximal section (i.e. section 50 slides with section 48, which slides within section 46, which slides within section 44, which slides within section 42). The proximal member 18 may comprise plastic or metal material, while the distal member 20 is metal or hard plastic. The distal member 20 is completely retractable into the proximal member 18 except for the two prong fork 22. In one embodiment illustrated in FIG. 3, the dimensions of the proximal member are: section 42 (5 inches in length. 578 inches in diameter); section 44 (3.875 inches in length, 0.535 inches in diameter); section 46 (4 inches in length, 0.495 inches in diameter); section 48 (4.125 inches in length, 0.455 inches in diameter); and, section 50 (4.250 inches in length, 0.415 inches in diameter).

Collection Device with Short Handle

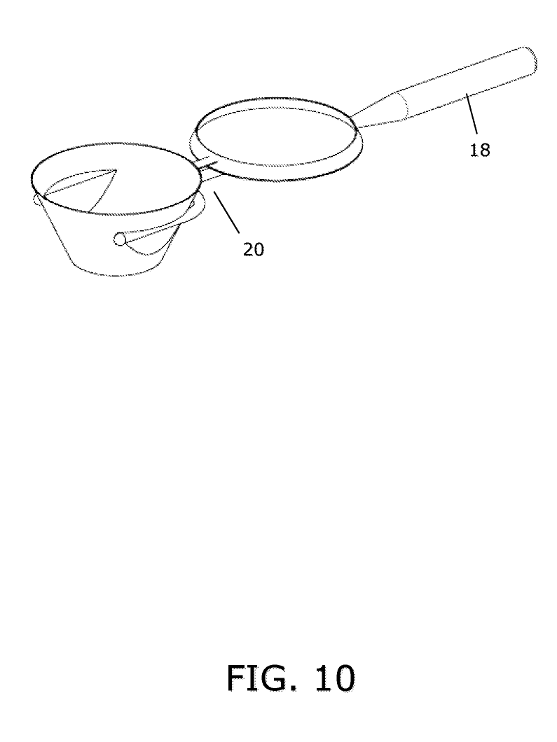

In alternative embodiments the handle may be of one section (versus telescopic), and of sufficient length to fit a user's palm(s), such as 7 to 10 inches in total length. For example, the handle may continue to comprise a two prong fork distal member 20 connected to a short, one section proximal member 18, as illustrated in FIGS. 9 and 10. Or, the handle may comprise a one prong distal member 21 connected to a short one section proximal member 18, as illustrated in FIGS. 13-15.

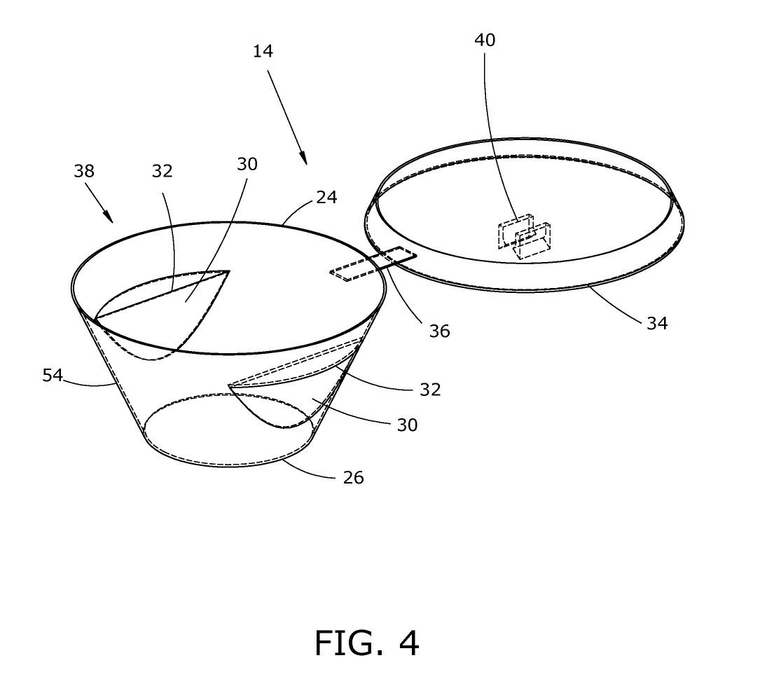

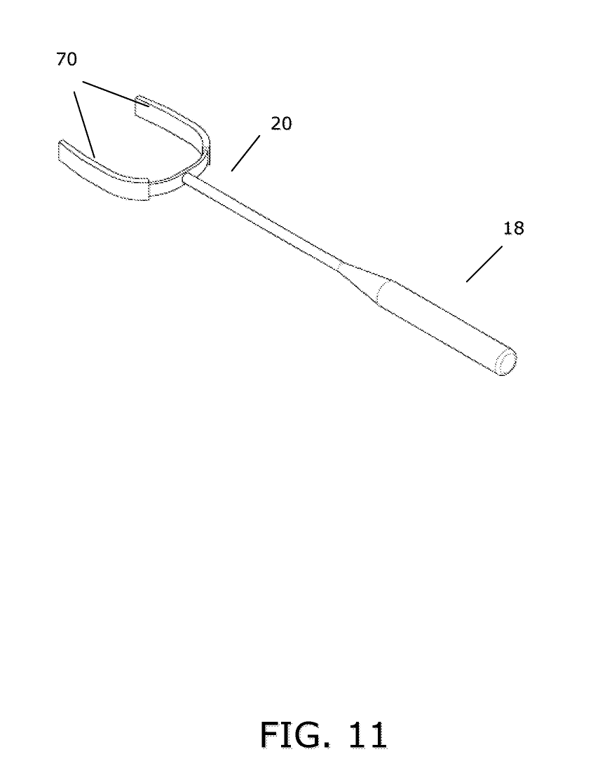

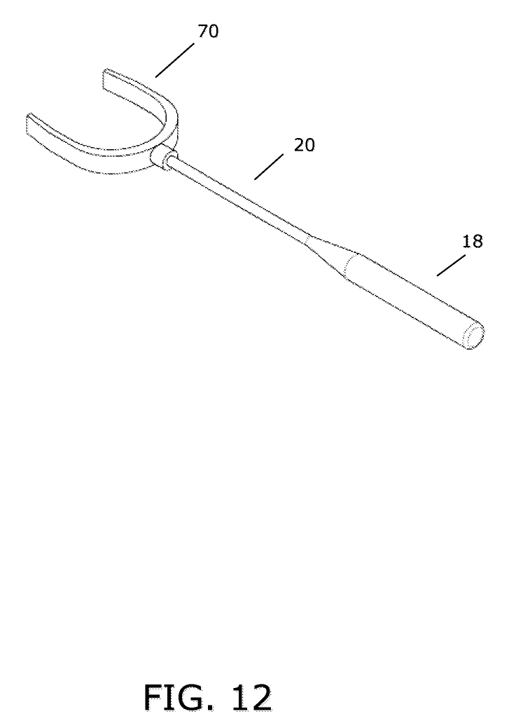

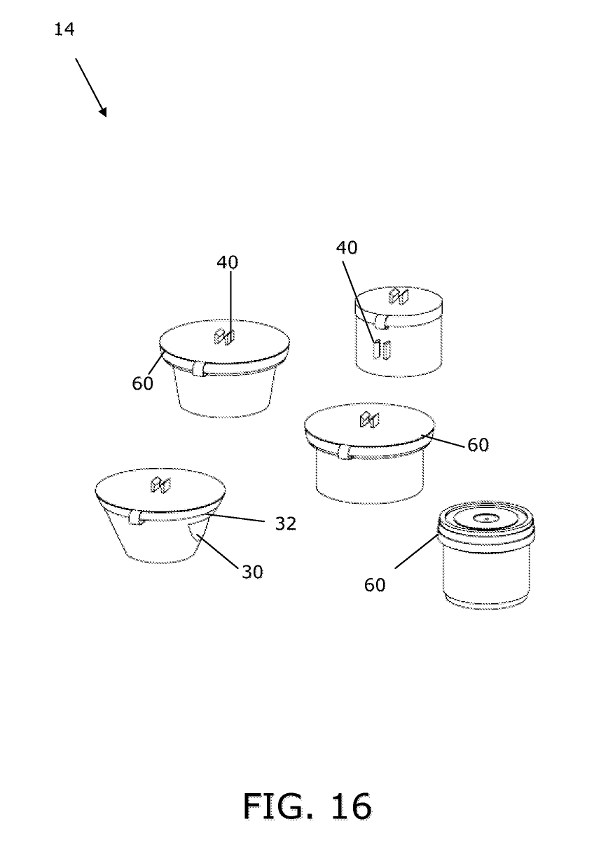

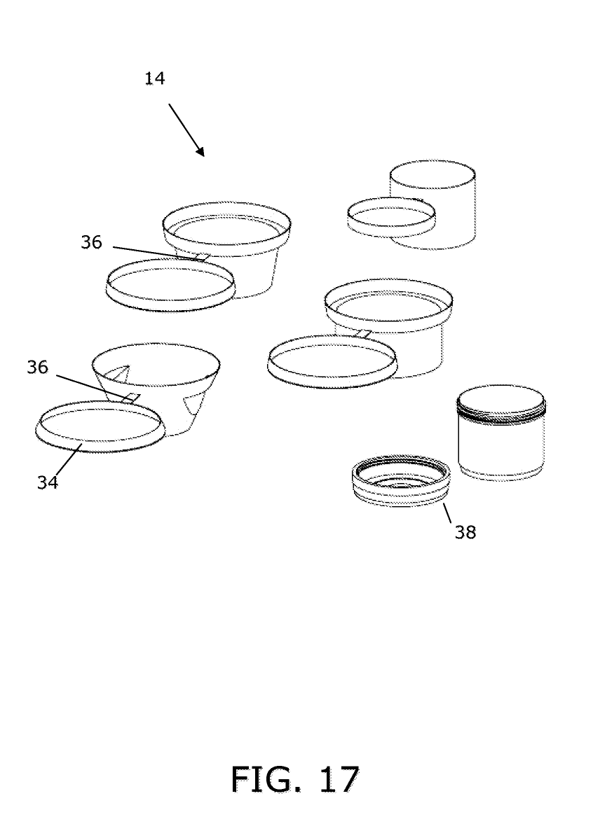

The distal members may also be coated with a material to assist the collection cup in adhering to the distal member. For example, the distal member 20 or 21 may be coated partially (e.g. FIG. 11) or completely (e.g. FIG. 12) with a material, such as a rubber like or similar non-slip and/or weather resistant material 70. It is noted that this coating is also applicable to the various versions of the handle including the telescopic version of FIGS. 1-7. The material may eliminate the need for the collection cup 14 to comprise a ledge created by the cup lid (e.g. see FIG. 16, 60), or an indentation with a ledge in the side wall of the cup (e.g. see FIGS. 4 and 16, 30, 32), to in order to hold the weight of the cup. For example, a rubber material would have the ability to provide a tight fitting grip like hold on the cup and be flexible enough to be used with a variety of cup diameters. The rubber fork could also be “opened/expanded” to adjust to fit around the cup rim; whether the cup 14 comprises a ledge or it is a commercially available collection cup with screw on cap (e.g. FIG. 17, 38).

### Collection Cup

### Frustoconical

One embodiment of the collection cup 14 is shown in further detail in FIG. 4. It comprises a cup 14 that is funnel or conical like shaped with a flat bottom surface 26, also known as an inverted frustoconical shape. Additionally, the diameter of the cup top rim or surface 24 is larger than the diameter of the bottom rim or surface 26. In another embodiment, the cup 14 is cylindrical in shape with the top rim or surface 24 the same diameter as the bottom rim or surface 26.

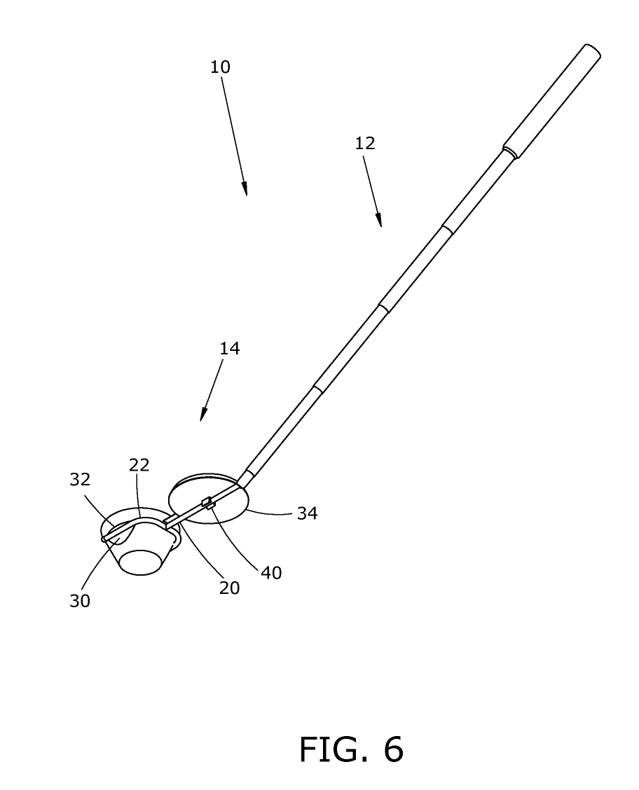

The cup 14, no matter its shape (cylindrical, conical, etc.) may further comprise an indentation 30 on opposing sides of the cup creating a ledge 32, as shown in FIG. 4. The handle's two prong fork 22 supports the weight of the collection cup 14 by lying flush against the underside of the ledge 32, as illustrated in FIGS. 1 and 6.

Alternatively, the cup may comprise a ledge 360 degrees around the cup, such as underneath the lid's outer rim that the two prong fork rests against (e.g. see FIG. 16, 60).

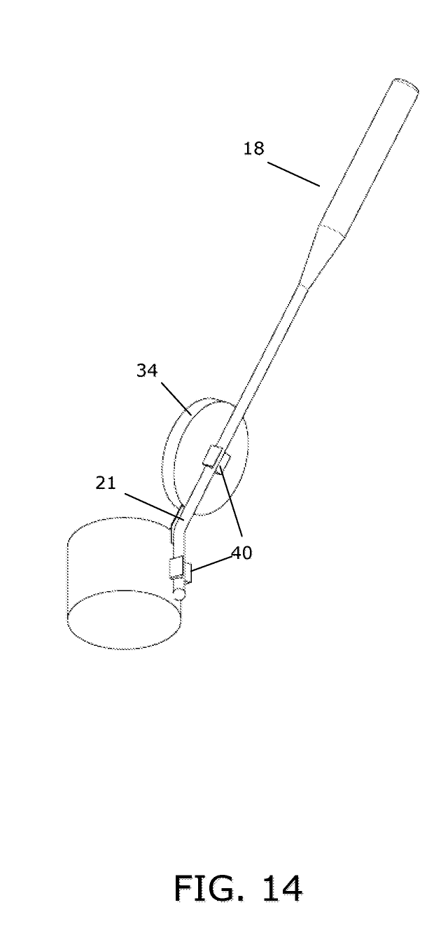

Alternatively, as shown in FIGS. 14-17, the collection cup 14 comprises a means on its side wall to attach to a one prong handle. For example, the means may comprise a fastener comprising two parallel plane members 40 that snap the lid 34 into place on the distal member 21.

Alternatively, the collection cup may comprise one already use, such as urinalysis cups that are utilized in a medical facility or via home health care supplier.

Cup Dimensions:

The size of the cup may depend upon its intended use—e.g. the size of the entity filing the cup. FIGS. 1, 2, and 4-6 illustrate one embodiment for a collection cup 14 for an animal, such as a domesticated pet. The exemplified cup 14 is 1.5 inches in height and 3.0 inches in diameter of the top rim 24, but other cup sizes are readily apparent to the skilled artisan.

Cup Lid:

The collection cup 14 further comprises a snap on or screw on lid 34. The lid may be entirely separable from the cup (e.g. FIG. 17, 38). Or the lid may be connected to cup 14 at or near the cup top rim 24 at a point on the rim 24 that is aligned with the handle distal member 20 or 21. Means of connection may comprise, for example, a tab 36, as illustrated in for example FIGS. 4, 16 and 17, comprising a flexible strip of material (e.g. plastic) attaching the lid 34 to the cup bottom. Other means of connecting the lid 34 to the cup 14 are envisioned within the present invention, such as a pivot joint or hinge (not shown).

When the lid 34 is on the cup top rim 24, as per FIG. 1, then the cup is sealed and no seepage of fluids from the cup is possible, no matter the orientation of the cup. Therefore, the collector is able to safely transport the cup 14, by storing it in a coat pocket, bag, etc.

The cup's lid 34 further comprises a means of attaching the top surface of the lid 34 to the distal member 20 or 21 of the handle 12, as shown in FIGS. 4-6, 14, and 16. This feature is important in keeping the lid from obstructing the filling of the cup when the device is in use. In one embodiment comprising a two prong fork distal handle member, as illustrated in FIGS. 4 and 6, a fastener comprising two parallel plane members 40 snap the lid 34 into place on the distal member 20. In another embodiment comprising a one prong fork connected to a short handle, as illustrated in FIGS. 14 and 16, a fastener comprising two parallel plane members 40 snap the lid 34 into place on the distal member 21.

In another embodiment (not shown), adhesive material (e.g. Velcro®) on the surface of the lid 34 adheres to like material on the distal member 20 or 21.

Cup Material:

The material of the cup may be transparent or opaque plastic that is liquid leek-proof and impermeable to seepage, to include from the top rim when the lid 34 is securely on the cup, and on the seam of the bottom surface 26 and the side wall 54. In one embodiment, the cup comprises Polyethylene terephthalate (PET) or Polypropylene (PP). In another embodiment, the cup comprises PET or PP while the clamp 40 on the cup's lid 34 is made from a hard plastic. Other types of materials are envisioned within the scope of the present disclosure, and they would be readily apparent to the skilled artisan.

### Additional Features

### Strap and Clip

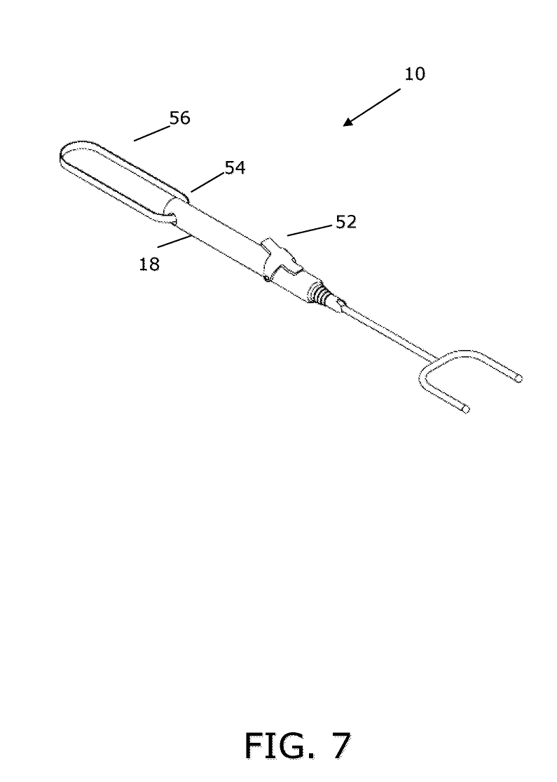

Additional features or aspects of the device comprise the handle 12 with a means for hanging bags or other containers that store the collection cup or other materials, such as diabetic test strips. For example, the handle 12 may further comprise a clasp 52 hanging from the underside of the handle's proximal end 18, as illustrated in FIG. 7.

The device 10 may further comprise a means to hang the device from a hook, door knob, etc. when not in use, and around the user's wrist when in use. Means may comprise, for example, a hole in the handle's proximal end with an attached strap. FIG. 7 provides an illustration of one embodiment with the handle's proximal end 18 comprising a hole 54 through which is threaded a strap 56.

### Light

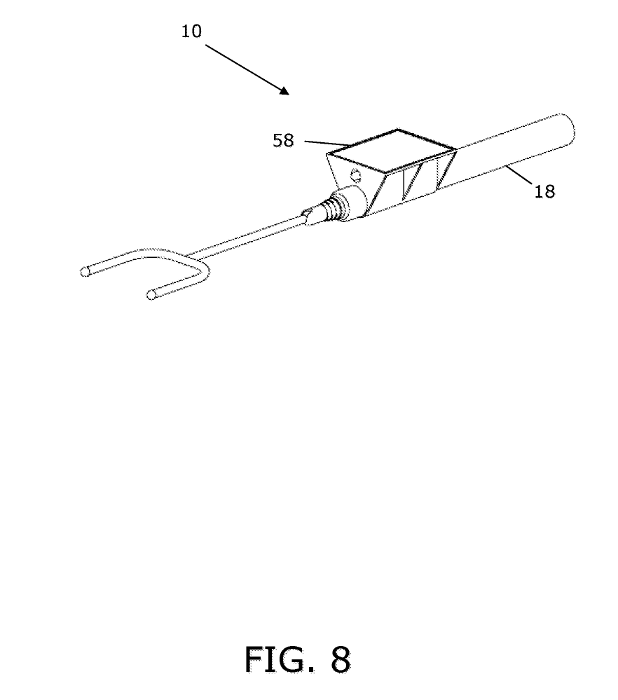

The device 10 may further comprise a means of illuminating the collection cup 14. A solar light, or a battery powered light, may be mounted on the handle 12, but in a position that does not hinder the handle from being completely collapsed as in FIG. 3. The light would then illuminate the collection cup. For example, FIG. 8 illustrates a light source 58 connected to the top of the proximal member 18 of a telescopic handle. It is noted, though, that a light source may be added to any version of the handle as disclosed herein.

Additionally, or alternatively, the cup may comprise materials that make it emit light to illuminate the entire cup and its contents. For example, the cup is made from plastic comprising a phosphor, such as Zinc Sulfide and Strontium Aluminate to enable the cup to “glow-in-the-dark”.

### Exemplification for Animal Use

A method of use of the collection device for use with an animal comprises the following steps, although not necessarily in this specific order. The User (e.g. Zoo keepers, farm, hospital or home users, or pet owner users, etc.) provides a collection cup of the present invention, the cup comprising for example: i) a frustoconical side wall comprising transparent or opaque material; ii) a flat bottom and an open top; and, iii) a sealable lid permanently attached at one point to the cup by a means that enables the lid to bend backwards onto the distal member.

The collector then provides the handle of the present invention, comprising for example: a collapsible-extendable handle with a proximal member and a distal member joined by a means to pivot the members relative to each other (e.g. ball pivot joint), and wherein the distal member is a two prong fork. The proximal member is hollow and telescopic with each section of the proximal member sliding into the adjoining proximal section.

The collector then slides the handle distal member around the cup side wall; bends the cup lid backwards and affixes the lid top surface to the distal member. It is further noted that when the collector slides the handle distal member around the cup, that the cup may further comprise a concave indentation on opposing sides of the cup aligned with the two prong fork distal member thus creating a ledge for one prong each to lie under while supporting the weight of the cup.

The collector then pivots the handle distal member relative to the handle proximal member, and extends the handle proximal member to enable the collector to stand erect while the cup is aligned horizontal to and near the ground and in the proper position under the animal.

After the cup is filled by the animal, the collector removes the cup from the handle distal member, then secures the lid on the cup (e.g. snapping it in place) wherein the cup is impermeable to fluid seepage; and, collapses the handle proximal member until all of the handle sections are stored within section 42 (see FIG. 3).

If the collector decides to test the sample onsite, then prior to fixing the lid of the filled cup, the collector may partially insert urinalysis test strips into the fluid, and conduct the test strip test accordingly. The collector may then store the cup and test strips in a bag hanging from a hook or clasp extending vertically downward from the handle proximal member.

Furthermore, the method may comprise the cup being automatically illuminated in a dark environment (before sunrise, after sunset, etc.), wherein the illumination is from a solar or battery powered light mounted on the handle and pointing at the cup; and/or, from the material of the cup, which comprises a light emitting phosphor or fluorescent dye.

Although there has been shown and described multiple embodiments of the present invention, it will be readily apparent to those skilled in the art that modifications may be made to thereto which do not exceed the scope of the appended claims. Therefore, the scope of the claims is only to be limited by the following claims.

What is claimed is:

1. A specimen collection device comprising:
a) a cylindrical handle with a proximal member and a distal member; and,
b) a transparent or opaque collection cup, comprising:
i) a cylindrical or an inverted frustoconical side wall;
ii) a flat bottom and an open top; and,
iii) a sealable lid permanently attached at one point to the cup by an attachment means that enables the lid to bend backwards onto the distal member.

2. The device of claim 1, wherein the handle distal member comprises a two prong fork joined to a solid tube, and wherein the solid tube is connected to and thinner than the handle's proximal member.

3. The device of claim 2, wherein the cup further comprises a concave indentation on opposing sides of the cup aligned with the two prong fork that creates a ledge for one prong each to lie under while supporting the weight of the cup.

4. The device of claim 2, wherein the cup further comprises a concave indentation 360 degrees around the cup that creates a ledge for one prong each of the two prong fork to lie under while supporting the weight of the cup.

5. The device of claim 1, wherein the handle proximal member is telescopic and extendable to a length to enable a collector to comfortably use the device while supporting the collection cup near the ground.

6. The device of claim 1, further comprising a means for the lid to attach to the handle distal member when the cup is in use.

7. The device of claim 1, further comprising a source of natural light to illuminate the cup.

8. The device of claim 1, wherein the handle distal member is a one prong fork with a slight bend near the distal end, and the cup side wall comprises a means to attach to the fork.

9. A specimen collection device comprising:
a) a handle with a proximal member and a distal member,
i) wherein the proximal member is a cylindrical; and,
ii) wherein the distal member comprises a two prong fork on the distal end that is joined to a tube on the proximal end, and wherein the tube is connected to and thinner than the handle's proximal member;
b) a cylindrical or inverted frustoconical shaped collection cup, comprising:
i) a side wall comprising a concave indentation that creates a ledge for one prong each of the fork to lie under while supporting the weight of the cup;
ii) a flat bottom and an open top; and,
iii) a sealable lid permanently attached at one point to the cup by a means that enables the lid to bend backwards onto the handle distal member; and,

10. The device of claim 9, the device further comprises a means for the distal and proximal member to pivot relative to each other; and, wherein the handle proximal member is hollow and telescopic with multiple sections that are extendable to a length sufficient to enable a collector to comfortably use the device.

11. The device of claim 9, wherein the side wall concave indentation is only on two opposing sides of the cup and aligned with the two prong fork, while not permitting the cup to slip out of the fork.

12. The device of claim 9, wherein the handle is about 7 to 10 inches in length.

13. The device of claim 9, further comprising a source of natural light to illuminate the cup.

14. A method of use of a patient specimen collection device by a collector, comprising:
a) providing a collection cup impermeable to seepage by liquids, wherein the cup comprises:
i) a cylindrical or inverted frustoconical side wall;
ii) a flat bottom and an open top;
iii) a sealable lid permanently attached at one point to the cup by a means that enables the lid to bend backwards onto the distal member;
b) providing a handle with a proximal member and a distal member, wherein the distal member comprises a one or two prong fork attachable to the cup side wall;
c) collecting a patient specimen into the cup;
d) securing the lid to the cup; and,
e) detaching the handle from the cup.

15. The method of claim 14 wherein the patient and a collector are human, may or may not be the same person, and the handle is about 7 to 10 inches in length and made of recyclable material.

16. The method of claim 14, wherein the cup side wall further comprises a concave indentation that creates a ledge for one prong each of the two prong fork to lie under while supporting the weight of the cup.

17. The method of claim 14, wherein the patient is an animal, the collector is human, the handle further comprises a means for the distal and proximal member to pivot relative to each other, and the handle proximal member is hollow and telescopic with multiple sections that are extendable to a length to enable the collector to comfortably use the device.

18. The method of claim 11, wherein the handle distal member is coated partially or completely with a non-slip or rubber material that prevents the cup from sliding out of the two prong fork.

19. The method of claim 14, wherein the cup is automatically illuminated in a dark environment.

20. The method of claim 14, wherein the handle is about 7 to 10 inches in length, and the handle distal member comprises a one prong fork with a slight bend near the distal end.
